(19) United States
(12) Patent Application Publication
(10) Pub. No.: US 2009/0055913 A1
(43) Pub. Date: Feb. 26, 2009

(54) Method for Secure Transmittal of PINs Over Telecommunications Networks

(75) Inventor: Alfredo C. Fajardo, Manila (PH)

Correspondence Address: INTELLECTUAL PROPERTY LAW GROUP LLP, 12 SOUTH FIRST STREET, SUITE 1205, SAN JOSE, CA, 95113, US

(73) Assignee: Veritas Mobile Solutions Pte. Ltd., Singapore (SG)

(21) Appl. No.: 12/158,313

(22) PCT Filed: Dec. 12, 2006
(86) PCT No.: PCT/SG2006/000386

§ 371 Date: Jun. 19, 2008

(30) Foreign Application Priority Data
Dec. 19, 2005 (SG) 200508202-9

(51) Int. Cl. H04L 9/32; G06F 21/00

(52) U.S. Cl. 726/7

(57) ABSTRACT

A method and facilitator system (11) to facilitate access by a subsciber (17) of a telecommunications provider (13) to a service or merchandise provided by a service provider (15) is disclosed. In the method and system, the facilitator (11) receives a first communication (23) from the subscriber (17) requesting provision of a service or merchandise via a telecommunications network. The facilitator (11) generates, and records a PIN against data from the communication, and sends (25) the PIN to the subscriber. The facilitator (11) awaits, via a tracked session, a second communication (27) from the subscriber (17) in confirmation of receipt of the PIN within a predetermined period of time, where if there is no confirmation within the predetermined period of time, the facilitator (11) voids the transaction. On successful confirmation (27) within the predetermined period of time, the facilitator (11) issues instructions (29) to the service provider (15) to provide the service or merchandise, and whereafter the facilitator (11) awaits a message (31) from the service provider (15) that the service or merchandise has been provided, and on receipt of the message (31), issues instructions (33) to the telecommunications provider (13) to charge the subscriber (17).

### FIELD OF THE INVENTION

This invention relates to performing commercial transactions using a telecommunications medium such as a mobile phone. In particular this invention provides a system and method for secure transmittal of serial numbers or PINs (personal identification numbers) associated with prepaid credit purchased from service providers by consumers for an account operated by the consumer. This invention has particular application in mobile phone and other personal communications technology where prepaid credit is purchased by consumers.

### BACKGROUND ART

The onset of pre-paid services world-wide has brought about the sale of prepaid blocks of credit, to top up credit on a user's account. While this has been manifested in the mobile phone market, for purchase of blocks of credit to top up the credit on prepaid mobile phone accounts, its application is not limited to this particular commercial activity, being also used in relation to other services such as internet connection, cable television, on-line gaming, etc.

The distribution medium for these blocks of credit hitherto has typically taken the form of a card bearing a serial number or PIN (Personal Identification Number). Typically, the PIN is concealed with an opaque scratchable strip by security printers during manufacture of the card. To access the service, the customer purchases such a “scratch card”, reveals the PIN by removing the scratchable strip, then contacts the service provider to provide relevant details, including the PIN, to gain access to the required service.

Serial numbers or PINs may be issued using media other than physical scratch cards to top up account credit, however. Likewise, in some cases a customer need not have an account to continually top up, and can simply pay to have the service provider issue a PIN that allows them to access the service (possibly up to a specified value or for a specified amount of time).

Often the transmittal of PINs after payment is besieged by carrier connection and or message delivery problems. Where PIN transmittal fails because of carrier connection and/or message delivery problems, the customer will have paid for the service, but be unable to access that service. These difficulties may also occur with email transmittal of PINs. It is therefore apparent that the secure transmittal of such PINs over wireless networks such as telecommunications networks poses a challenge.

Accordingly it is an object of this invention to provide a method and system for secure transmittal of PINs for activation of a service to which purchased credit relates, which overcomes the aforementioned difficulty.

Throughout the specification, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the invention there is provided a method of securely transmitting a PIN and/or user name to facilitate access by a subscriber of a telecommunications provider to a service or merchandise provided by a service provider, said method having steps of:
receiving a first communication from the subscriber being a request for provision of a service or merchandise via a telecommunications network;
generating, and recording a PIN against data from said first communication, and sending the PIN to the subscriber;
awaiting, via a tracked session, a second communication from the subscriber in confirmation of receipt of the PIN within a predetermined period of time, where if there is no confirmation within the predetermined period of time, the facilitator voids the transaction; and where on successful confirmation within the predetermined period of time, the facilitator issues instructions to the service provider to provide the service or merchandise; and,
awaiting a message from the service provider that the service or merchandise has been provided, and issuing instructions to the telecommunications provider to charge the subscriber.

Preferably said data from said first communication and said second communication includes a unique identifier pertaining to the subscriber.

Preferably the communication comprises a blank message containing no text. With this arrangement, the subscriber would understand beforehand that the sending of the communication constituted a request for issue of a PIN and/or user name for goods or services of a predetermined value and from a predetermined vendor. With such an arrangement, the sending of a blank message to a predetermined shortcode or email address would constitute a request for issue of a PIN and/or user name for goods or services of a predetermined value and from a predetermined vendor. A plurality of shortcodes or email addresses could be allocated by the telecommunications provider, each being associated with the issuing of a PIN and/or user name for differing or the same goods or services and/or the same goods or services of differing predetermined value and/or from differing predetermined vendors. By the expression “blank message”, a message containing no manually entered text or numerals or other indicia is intended. It is understood that SMS or email messages will contain information in headers and the like, from which the identity of the sender can be ascertained.

Preferably the communication from said subscriber includes a service provider ID, identifying the service provider to which the PIN and/or user name relates.

Preferably the communication from said subscriber includes a service or goods ID, identifying the service or good provided by the said service provider to which the PIN and/or user name relates.

Preferably the communication from the subscriber includes a monetary value or unit value indication for the value of the transaction.

The inclusion of such information is preferably provided in predetermined format. Where more information is provided for in communications, then fewer shortcodes or email addresses are required, as it can be determined what the subscriber requires, from the message content.

The subscriber may or may not be registered to access this service.

Preferably the telecommunications provider is selected from a wireless service such as a mobile phone service, or the internet. This does not preclude the telecommunications provider from being a land-line based service.

Preferably the unique identifier is the email address or phone number used by the subscriber.

Preferably in the same step of sending the PIN to the subscriber, the facilitator sends instructions to the subscriber to confirm receipt of the PIN from the facilitator.

Preferably the tracked session is performed by suffixing and/or by the authentication method and system described in the applicant's patent specification titled “Authentication Method and System” which is the subject of patent application PCT/SG2004/000239, the contents of which are incorporated herein by cross-reference.

Preferably the subscriber account with the telecommunications provider is maintained in credit by the subscriber as a prepaid debit account, and if the prepaid debit account does not have enough credit or is for some reason not charged, the transaction authenticated details will be withheld and the transaction subsequently voided by the facilitator.

Also in accordance with the invention there is provided a facilitator to facilitate access by a subscriber of a telecommunications provider to a service or merchandise provided by a service provider, said facilitator receiving a first communication from the subscriber being a request for provision of a service or merchandise via a telecommunications network, where said facilitator generates, and records a PIN against data from said communication, and sends the PIN to the subscriber; whereafter said facilitator awaits, via a tracked session, a second communication from the subscriber in confirmation of receipt of the PIN within a predetermined period of time, where if there is no confirmation within the predetermined period of time, the facilitator voids the transaction, and where on successful confirmation within the predetermined period of time, the facilitator issues instructions to the service provider to provide the service or merchandise, and whereafter the facilitator awaits a message from the service provider that the service or merchandise has been provided, and on receipt of said message, said facilitator issues instructions to the telecommunications provider to charge the subscriber.

Preferably said data from said first communication and said second communication includes a unique identifier pertaining to the subscriber.

Preferably when said facilitator sends the PIN to the subscriber, said facilitator starts a timer to time out said predetermined period of time, said timer being recorded against said PIN and data from said first communication.

Preferably when said facilitator receives said second communication message, said facilitator checks recorded PIN and data from said first communication against data contained in said second communication message, and when a match is found, marks the record PIN and data from said first communication as being authenticated.

Preferably at the end of said predetermined period, said facilitator PIN and data from said first communication are deleted if unauthenticated.

Preferably the communication comprises a blank message containing no text. With this arrangement, the subscriber would understand beforehand that the sending of the communication constituted a request for issue of a PIN and/or user name for goods or services of a predetermined value and from a predetermined vendor. With such an arrangement, the sending of a blank message to a predetermined shortcode or email address would constitute a request for issue of a PIN and/or user name for goods or services of a predetermined value and from a predetermined vendor. A plurality of shortcodes or email addresses could be allocated by the telecommunications provider, each being associated with the issuing of a PIN and/or user name for differing or the same goods or services and/or the same goods or services of differing predetermined value and/or from differing predetermined vendors. By the expression “blank message”, a message containing no manually entered text or numerals or other indicia is intended. It is understood that SMS or email messages will contain information in headers and the like, from which the identity of the sender can be ascertained.

Preferably the communication from said subscriber includes a service provider ID, identifying the service provider to which the PIN and/or user name relates.

Preferably the communication from said subscriber includes a service or goods ID, identifying the service or good provided by the said service provider to which the PIN and/or user name relates.

Preferably the communication from the subscriber includes a monetary value or unit value indication for the value of the transaction.

The inclusion of such information is preferably provided in predetermined format. Where more information is provided for in communications, then fewer shortcodes or email addresses are required, as it can be determined what the subscriber requires, from the message content.

The subscriber may or may not be registered to access this service.

Preferably the telecommunications provider is selected from a wireless service such as a mobile phone service, or the internet. This does not preclude the telecommunications provider from being a land-line based service.

Preferably the unique identifier is the email address or phone number used by the subscriber.

Preferably in the same step of -sending the PIN to the subscriber, the facilitator sends instructions to the subscriber to confirm receipt of the PIN from the facilitator.

Preferably the tracked session is performed by suffixing and/or by the authentication method and system described in the applicant's patent specification titled “Authentication Method and System” which is the subject of patent application PCT/SG2004/000239, the contents of which are incorporated herein by cross-reference.

Preferably the subscriber account with the telecommunications provider is maintained in credit by the subscriber as a prepaid debit account, and if the prepaid debit account does not have enough credit or is for some reason not charged, the transaction authenticated details will be withheld and the transaction subsequently voided by the facilitator.

### BRIEF DESCRIPTION OF THE DRAWINGS

A preferred embodiment of the invention will now be described in the following description, made with reference to the attached drawing figure which is a diagram showing steps in the method of the invention.

### BEST MODE(S) FOR CARRYING OUT THE INVENTION

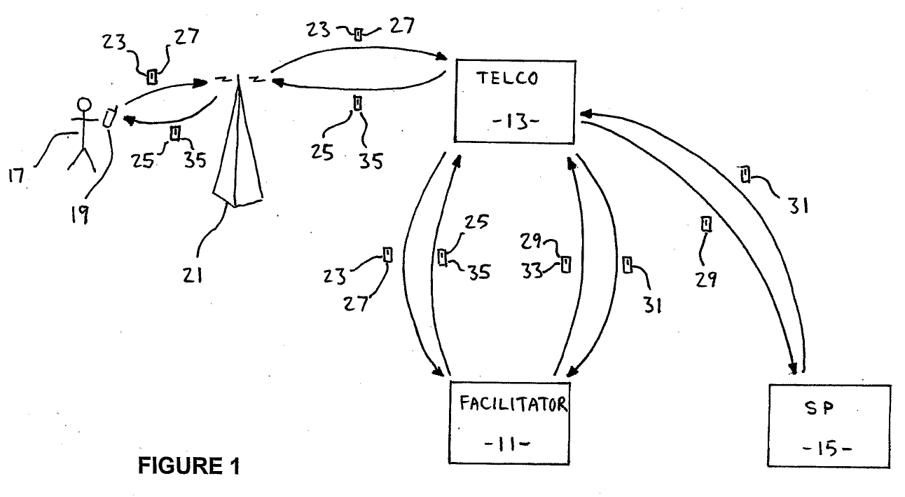

In the method of the embodiment a facilitator 11 is provided in communication with at least one telecommunications provider 13 and at least one third party service provider 15. The telecommunications provider 13 has a number of subscribers 17 having mobile phones 19 communicating through mobile phone towers 21 in known manner. The telecommunications provider 13 and third party service provider 15 may communicate using a mobile phone technology such as SMS (short message service), or using internet e-mail. The communication means between the facilitator 11, telecommunications provider 13 and third party service provider 15 are not illustrated in FIG. 1. The facilitator 11 may be provided as a stand-alone server, in communication with the telecommunications provider 13, as described in this embodiment, or in an alternative embodiment may be incorporated into the systems of the telecommunications provider, in a server sharing applications with other applications run by the telecommunications provider. According to the method of the embodiment, the subscriber 17 sends a message 23 requesting access to a particular service to the facilitator 11. The message is in the following format:

PIN ABCD XYZ 1234
where PIN identifies that the subscriber is requesting issuance of a PIN
ABCD identifies the third party service provider
XYZ identifies the service or good being requested from the service provider
1234 is the monetary or unit value that the subscriber requires to be set against the service sought by the third party service provider.

It should be noted that in an alternative embodiment, it may not be necessary to include the PIN keyword in cases where the shortcode to which the communication is sent is solely dedicated to the issuance of PINs and/or username/password. Likewise, where only one service or good is provided by the service provider, it is not necessary to specify the service or good XYZ. Similarly, it should be noted that where there is only a single unit value available, the need to enter an amount would be eliminated.

The facilitator 11 identifies the unique identifier used to send the message, either the mobile phone number or the e-mail address. In GSM systems, an SMS to a shortcode would pass through an SMSC which generates a Delivery Service Report (DSR) which contains the details of the message inclusive of the UIN (User Identity Number)/mobile phone number. In the case of e-mail, the message details are included in the header. It is understood that anyone can spoof an e-mail message by simply specifying a return address, and for this reason where e-mail is used as the communications medium the sender details are retrieved from the message header.

In response, the facilitator sends a message 25 containing a PIN back to the subscriber via the unique identifier and requests confirmation of receipt of the PIN from the subscriber.

The facilitator stores the unique identifier and the PIN that has just been sent, cross referenced along with a timer value. The timer value initializes at a predetermined period of 72 hours and is periodically updated so as to count down in real time. The predetermined period of time can be any period that is practical for the subscriber to take the next step.

Within the predetermined period, i.e., before the timer value reaches zero, the subscriber must confirm the transaction by sending another message 27 to the facilitator using the same communication medium as utilized to send the initial request for a PIN. Once the transaction has been confirmed, the transaction is deemed authenticated by the facilitator.

The manner in which the message 25 or Delivery Service Receipt (DSR) message 25 is sent from the facilitator to the SMSC, depends upon whether shortcode suffixing is allowed or not, and depends upon whether the subscriber is already registered with the facilitator.

Where shortcode suffixing is allowed and the subscriber must be pre-registered with the facilitator, the facilitator will have a record of subscriber PIN recorded against the mobile phone number of the subscriber. The subscriber sends an SMS to the facilitator predetermined shortcode, for example shortcode 222, requesting the facilitator to issue a third party PIN/password to allow the subscriber to access a service provided by the third party service provider. The facilitator processes the request and prompts subscriber to reply with his subscriber PIN to a dynamically generated suffixed shortcode, for example 22212345 where 12345 is a dynamically generated suffix.

The subscriber replies 27 and the facilitator checks to determine if the subscriber PIN and mobile phone number matches the subscriber PIN recorded against the mobile phone number with the facilitator, and if the suffixed shortcode is correct, the facilitator then allows the authenticated transaction to continue.

In cases where shortcode suffixing is allowed and subscriber registration is not required, on receipt of a request for a third party service provider PIN from the subscriber, the facilitator prompts the subscriber to respond with a challenge to a dynamically suffixed shortcode. For example, the subscriber requests issue of a third party service provider PIN by sending an SMS message 23 to the facilitator shortcode 222. The facilitator then sends a message 25 from shortcode 222 suffixed with CLI (carrier line identifier) 1234, and asks the subscriber to reply with a challenge code which could be alphanumeric, in this case “DOG”, to an SMS message with CLI 2221234. The subscriber responds 27 as instructed, and the facilitator then compares the subscriber mobile number, dynamic shortcode, and challenge code, and if they match the facilitator then allows the authenticated transaction to continue.

Most mobile network operators do not allow suffixing with regards to their shortcodes. So a message 23 sent by a subscriber to a shortcode will be processed and message 25 will use the same CLI of the original message. In the case where the mobile network operators do not allow suffixing with regard to their shortcodes, and where the subscriber must be pre-registered with the facilitator, the facilitator will have a record of subscriber PIN recorded against the mobile phone number of the subscriber. The subscriber sends an SMS 23 to the facilitator predetermined shortcode, requesting the facilitator to issue a third party service provider PIN/password to allow the subscriber to access a service provided by the third party service provider. The facilitator processes the request and prompts the subscriber to reply with his PIN plus a dynamically generated alphanumeric sequence contained in message 25.

The subscriber replies 27, and upon matching the subscriber mobile phone number, subscriber PIN, and alphanumeric sequence (which acts as the session tracker), the facilitator then allows the authenticated transaction to continue.

In cases where shortcode suffixing is not allowed and subscriber registration is not required, on receipt of a request 23 for a third party service provider PIN from the subscriber, the facilitator prompts the subscriber to reply with a challenge code contained in message 25. Upon receipt of the correct challenge code contained in message 27 from the subscriber, the facilitator then checks the challenge code with the mobile phone number and if there is a match with details from the earlier response from the facilitator to the subscribers request, the facilitator allows the transaction to continue.

Once the transaction has been authenticated as described above the facilitator informs 29 the third party service provider of the details of the transaction. The service provider then activates the PIN and/or user name and password delivered to the subscriber in relation to the transaction. The service provider informs 31 the facilitator of the successful activation of the PIN and/or user name and password, whereupon the facilitator instructs 33 the telecommunications provider or third party banker to charge the subscriber the requisite amount. The facilitator then informs 35 the subscriber by SMS that the transaction has been successfully authenticated, the PIN has been activated and the subscriber's account has been debited.

Upon issuance, the PIN transmitted to the subscriber is not activated. That is, it is not valid for access to the service provided by the service provider. Attempt to use the inactive PIN by the subscriber will result in denial of access to the service. The PIN is activated (made valid) by the service provider only and immediately upon receipt of information from the facilitator that the subscriber has confirmed receipt as per the process described above. The subscriber is then able to use the PIN to access the service.

The telecommunications provider may act as the collection agent that charges the subscriber through a mechanism debiting the subscriber's account with the telecommunications provider. Debiting is done only and immediately upon instruction from the facilitator. The amount debited from the subscriber's credit is likewise based on the instructions of the facilitator.

In cases where it is a third party banker or clearing house that keeps track of stored value belonging or assigned to the subscriber, it is the third party banker or clearing house that effects the debit of the requisite amount from the subscriber's credit only and immediately upon receipt of instructions from the facilitator.

In cases where the facilitator acts as the clearing house that keeps track of the stored value belonging or assigned to the subscriber, the facilitator debits the subscriber's credit only and immediately upon successful authentication of the confirmation transaction described above.

The facilitator then informs the subscriber by SMS that the transaction has been successfully completed and that the subscriber has been charged the requisite amount.

It is in this manner that the subscriber is charged only upon confirmation from the subscriber that the PIN that is purchased has in fact been successfully delivered.

Transfer of value or funds in relation to the successful purchase and delivery of the PIN is effected in the manner described below.

Where the telecommunications provider acts as the collection agent, the telecommunications provider transfers the requisite amount to the facilitator or to the service provider immediately after each successful sale, after an agreed reconciliation period (for example, weekly or bi-weekly) or after a certain number or value of transactions is reached, depending on agreements made between all parties. The transfer of amount is done through bank transfer, cash payment, or any other agreed method. If the facilitator first receives the funds on behalf of the service provider, the facilitator transfers the requisite amount to the service provider in the manner and frequency agreed to by both parties.

Where a third party banker or clearing house is employed to keep track of stored value belonging or assigned to the subscriber, the third party banker or clearing house transfers the requisite amount to the facilitator or to the service provider immediately after each successful sale, after an agreed reconciliation period (for example, weekly or bi-weekly) or after a certain number or value of transactions is reached, depending on agreements made between all parties. The transfer of amount is done through bank transfer, cash payment, or any other agreed method. If the facilitator first receives the funds on behalf of the service provider, the facilitator transfers the requisite amount to the service provider in the manner. and frequency agreed to by both parties.

Where the facilitator acts as the clearing house that keeps track of the stored value belonging or assigned to the subscriber, the facilitator transfers the requisite amount to the service provider immediately after each successful sale, after an agreed reconciliation period (for example, weekly or bi-weekly) or after a certain number or value of transactions is reached, depending on agreements made between all parties. The transfer of amount is done through bank transfer, cash payment, or any other agreed method.

It should be appreciated that the scope of the invention is not limited to the particular embodiment described herein.

1. A method of securely transmitting a PIN and/or user name to facilitate access by a subscriber of a telecommunications provider to a service or merchandise provided by a service provider, said method having steps of:
receiving a first communication from the subscriber being a request for provision of a service or merchandise via a telecommunications network;
generating, and recording a PIN against data from said first communication, and sending the PIN to the subscriber;
awaiting, via a tracked session, a second communication from the subscriber in confirmation of receipt of the PIN within a predetermined period of time, where if there is no confirmation within the predetermined period of time, the facilitator voids the transaction; and where on successful confirmation within the predetermined period of time, the facilitator issues instructions to the service provider to provide the service or merchandise; and,
awaiting a message from the service provider that the service or merchandise has been provided, and issuing instructions to the telecommunications provider to charge the subscriber.

2. A facilitator to facilitate access by a subscriber of a telecommunications provider to a service or merchandise provided by a service provider, said facilitator receiving a first communication from the subscriber being a request for provision of a service or merchandise via a telecommunications network, where said facilitator generates, and records a PIN against data from said communication, and sends the PIN to the subscriber; whereafter said facilitator awaits, via a tracked session, a second communication from the subscriber in confirmation of receipt of the PIN within a predetermined period of time, where if there is no confirmation within the predetermined period of time, the facilitator voids the transaction, and where on successful confirmation within the predetermined period of time, the facilitator issues instructions to the service provider to provide the service or merchandise, and whereafter the facilitator awaits a message from the service provider that the service or merchandise has been provided, and on receipt of said message, said facilitator issues instructions to the telecommunications provider to charge the subscriber.
